(19) United States
(12) Patent Application Publication
(10) Pub. No.: US 2026/0241805 A1
(43) Pub. Date: Aug. 20, 2026

(54) MOBILE MACHINE ELECTRIC POWER MODULE

(71) Applicant: Moog Inc., East Aurora, NY (US)

(72) Inventors: Robert M. Bauer, East Aurora, NY (US); Eric J. Connor, Austin, TX (US); Daniel R. Giza, Depew, NY (US)

(21) Appl. No.: 19/160,961

(22) PCT Filed: Feb. 27, 2024
(86) PCT No.: PCT/US2024/017389

§ 371 Date: Aug. 29, 2025

Related U.S. Application Data
(60) Provisional application No. 63/449,292, filed on Mar. 1, 2023.
(60) Provisional application No. 63/458,390, filed on Apr. 10, 2023.

(51) Int. Cl. B60L 50/64; B60L 1/00; B60L 1/14; B60L 53/16; H01M 10/42; H01M 10/46; H01M 10/613; H01M 10/625; H01M 10/6568; H01M 50/204; H01M 50/249

(52) U.S. Cl. CPC B60L 50/64; B60L 1/003; B60L 1/14; B60L 53/16; H01M 10/425; H01M 10/46; H01M 10/613; H01M 10/625; H01M 10/6568; H01M 50/204; H01M 50/249; B60L 2200/40; H01M 2010/4271; H01M 2220/20

(57) ABSTRACT

A modular mobile machine electric power system comprising an insulated housing, a battery contained in the housing, a charging inlet port in the housing, charging electronics contained in the housing and connected between the charging inlet port and 2024/182338 the battery, a motor power outlet port in the housing configured to be operatively connected to an electric motor of a mobile machine, discharging electronics contained in the housing and connected between the battery and the motor power outlet port, a battery thermal management system contained in the housing, a controller contained in the housing, and the housing comprising a mechanical attachment configured to be operatively connected to the mobile machine.

WO

### CROSS-REFERENCE TO RELATED APPLICATIONS

This application claims the benefit under Articles 4 and 8 of the Stockholm Act of the Paris Convention for the Protection of Industrial Property of U.S. patent application Ser. No. 63/458,390, filed on Apr. 10, 2023 and U.S. patent application Ser. No. 63/449,292, filed on Mar. 1, 2023, which applications are incorporated herein by reference in their entireties.

### TECHNICAL FIELD

The present disclosed subject matter relates generally to the field of mobile machines, and more particularly to an improved mobile machine electric power module.

### BACKGROUND ART

Movable machinery, heavy equipment, heavy machinery, or earthmover equipment refers to heavy-duty vehicles specially designed to execute construction tasks, most frequently involving earthwork operations or other large construction tasks. Some examples of movable machinery are bulldozers, agricultural tractors, excavators, cranes, backhoes, and loaders. Movable machinery usually comprises five equipment systems: implement, traction, structure, power train, and control. Movable machinery functions through the mechanical advantage of a simple machine, where the ratio between input force applied and force exerted is multiplied, making tasks which could take hundreds of people and weeks of labor without heavy equipment far less intensive in nature. Some movable machinery uses hydraulic drives as a primary source of motion and actuation.

### BRIEF SUMMARY

With parenthetical reference to corresponding parts, portions or surfaces of the disclosed embodiment, merely for the purposes of illustration and not by way of limitation, the present disclosure provides a modular mobile machine electric power system (40), comprising a housing (42), a battery (56A-56C) contained in the housing (42), a charging inlet port (46) in the housing (42), charging electronics (48, 49, 52, 54, 58, 60) contained in the housing (42) and connected between the charging inlet port (46) and the battery (56A-56C), a motor power outlet port (100) in the housing (42) configured to be operatively connected to an electric motor (90) of a mobile machine (20), discharging electronics (50, 54, 58, 59, 60, 68, 69) contained in the housing (42) and connected between the battery (56A-56C) and the motor power outlet port (100), a battery thermal management system (80, 82, 84, 86, 88, 128) contained in the housing (42), a controller (62) contained in the housing (42), and the housing (42) comprising a mechanical attachment configured to be operatively connected to the mobile machine (20).

In an exemplary embodiment, the housing (42) comprises an ambient air-sealed and insulated first compartment (44A) and an ambient air-open second compartment (44B) and the battery (56A-56C) and the controller (62) are contained in the first compartment (44A). In an exemplary embodiment, the battery (56A-56C) comprises a plurality of batteries (56A-56C) and battery management electronics (58). In an exemplary embodiment, the modular system further comprises a signal, communication, or data port (61, 106) in the housing connected to the controller (62). In an exemplary embodiment, the signal port (61) comprises an ethernet port. In an exemplary embodiment, the signal port (106) is configured to be operatively connected to the electric motor (90) of the mobile machine (20). In an exemplary embodiment, the signal port (106) is configured to be operatively connected to a user interface (36) of the mobile machine (20).

In an exemplary embodiment, the charging electronics comprise a high voltage relay or busbar (54). In an exemplary embodiment, the discharging electronics comprise a low voltage DC bus (59). In an exemplary embodiment, the discharging electronics comprise a voltage converter (68, 69).

In an exemplary embodiment, the modular system (40) further comprises a low voltage outlet port (102) in the housing (42). In an exemplary embodiment, the low voltage outlet port (102) is configured to be operatively connected to an electric load of the mobile machine (20). In an exemplary embodiment, the electric load is selected from the group consisting of a battery (97), a user interface (36), a cabin air conditioner (31) and vehicle lighting (33).

In an exemplary embodiment, the battery thermal management system comprises a first coolant path (126), a first coolant pump (82) configured to convey a liquid coolant in the first coolant path, and a first heat exchanger (86, 80, 84) in the first coolant path. In an exemplary embodiment, the heat exchanger may comprise at least one of a chiller (86), a heater (80), a radiator (84), and a cooling fan (84). In an exemplary embodiment, the battery thermal management system comprises a second coolant path (128) separate from the first coolant path (126), a second coolant pump (83) configured to convey a liquid coolant in the second coolant path, and a second heat exchanger (87) in the second coolant path. In an exemplary embodiment, the modular system may further comprise a controller battery configured to operatively power the controller (62).

In an exemplary embodiment, the mobile charging system comprises a plurality of detection sensors (71) operable to detect an object within a range of the housing and to transmit a signal to the controller. In an exemplary embodiment, the plurality of perception sensors comprise ultrasonic sensors. In an exemplary embodiment, the controller is programmed to monitor for obstacles within a threshold range using the sensors and to provide a safety command in response to detection of an obstacle within the threshold range.

In an exemplary embodiment, the mechanical attachment comprises a housing flange having a plurality of mounting holes and a plurality of mounting bolts configured to extend through the respective mounting holes and to be operatively connected to a base (30) of the mobile machine (20). In an exemplary embodiment, the mobile machine (20) comprises a hydraulic pump (29) driven by the electric motor (91) and at least one hydraulic actuator connected to the hydraulic pump (29). In an exemplary embodiment, the mobile machine (20) comprises an excavator.

In an exemplary embodiment, the system comprises a plurality of parts, packaging, and interfaces that interact as a modular system. For example, the modular system may comprise an electrical energy storage system (e.g., a battery and associated components), and an electric motor that is meant to replace an internal combustion engine. In an exemplary embodiment, the modular system comprises an electrical energy pack including at least one battery and electrical and/or electronic components needed to power a machine (e.g., a piece of heavy equipment). In an exemplary embodiment, the modular system comprises at least one motor used to drive the motion axis of the machine. In an exemplary embodiment, there are a plurality of connections between the module and the mobile machine, for example, hydraulic, coolant, refrigerant, communication, analog signals, audio, video, and high voltage/power or electrical. These connections may be flexible and/or universal. In an exemplary embodiment, a master interface could be used for a single conduit to facilitate multiple connections.

In an exemplary embodiment, the module outer shell or housing may be designed to directly mate to a specific make, model, and year of mobile machine. In an exemplary embodiment, the system includes a mechanical adapter that interfaces with the mobile machine and has an alternate surface designed to accept a standard module. In an exemplary embodiment, a module may be designed to directly interface with a particular make, model, and year of the mobile machine or a mechanical adapter that interfaces with the mobile machine and has an alternate surface to accept a standard module.

According to aspects of the present disclosure, there is provided a method to simply and efficiently integrate the electrical equipment, electronics, batteries, and motors with a piece of heavy equipment with modular components such that the finished machine is easily serviceable and has a very high level of component, subassembly, and assembly interchangeability with other equipment.

The following will describe embodiments of the present disclosure, but it should be appreciated that the present disclosure is not limited to the described embodiments and various modifications of the disclosure are possible without departing from the basic principles. The scope of the present disclosure is therefore to be determined solely by the appended claims.

### BRIEF DESCRIPTION OF THE DRAWINGS

Various embodiments are disclosed, by way of example only, with reference to the accompanying schematic drawings below in which corresponding reference symbols indicate corresponding parts. The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1A is a front top perspective view of a modular electric mobile machine assembly.

FIG. 1B is a partial rear perspective view of the modular electric mobile machine assembly shown in FIG. 1A.

FIG. 1C is a partial right side elevational view of the modular electric mobile machine assembly shown in FIG. 1A.

FIG. 1D is a partial left side elevational view of the modular electric mobile machine assembly shown in FIG. 1A.

FIG. 1E is a partial top plan view of the modular electric mobile machine assembly shown in FIG. 1A.

FIG. 2 is a detail view of the modular electric mobile machine assembly shown in FIG. 1B.

FIG. 3A is an exploded rear perspective view of the mobile machine electric power module shown in FIG. 1A.

FIG. 3B is a partial rear elevational view of the mobile machine electric power module shown in FIG. 3A.

FIG. 3C is a front elevational view of the mobile machine electric power module shown in FIG. 3A.

FIG. 3D is a bottom plan view of the mobile machine electric power module shown in FIG. 3A.

FIG. 3E is a top plan view of the mobile machine electric power module shown in FIG. 3A.

FIG. 3F is a right side elevational view of the mobile machine electric power module shown in FIG. 3A.

FIG. 3G is a left side elevational view of the mobile machine electric power module shown in FIG. 3A.

FIG. 4 is a cross-sectional view of the modular electric mobile machine assembly taken generally along line 4 -4 in FIG. 3B.

FIG. 5 is a cross-sectional view of the modular electric mobile machine assembly taken generally along line 5 -5 in FIG. 3B.

FIG. 6 is a schematic view of the modular electric mobile machine assembly shown in FIG. 1A.

FIG. 6A is a partial schematic view of the high voltage connectivity shown in FIG. 6.

FIG. 6B is a partial schematic view of the low voltage connectivity shown in FIG. 6.

FIG. 6C is a partial schematic view of the data communication connectivity shown in FIG. 6.

FIG. 6D is a partial schematic view of the thermal management fluid connectivity shown in FIG. 6.

### DETAILED DESCRIPTION OF THE EMBODIMENTS

At the outset, it should be clearly understood that like reference numerals are intended to identify the same structural elements, portions, or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal,” “vertical,” “left,” “right,” “up” and “down,” as well as adjectival and adverbial derivatives thereof (e.g., “horizontally,” “rightwardly,” “upwardly,” etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of” is used herein.

It is to be understood that the specific assemblies and systems illustrated in the attached drawings and described in the following specification are simply exemplary embodiments. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where they are used herein, the terms “first,” “second,” and so forth, do not necessarily denote any ordinal, sequential or priority relation, but are simply used to distinguish one element or set of elements more clearly from another element or set of elements, unless specified otherwise.

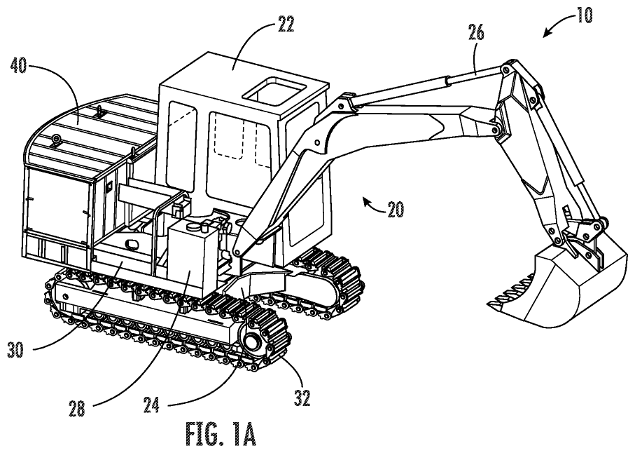

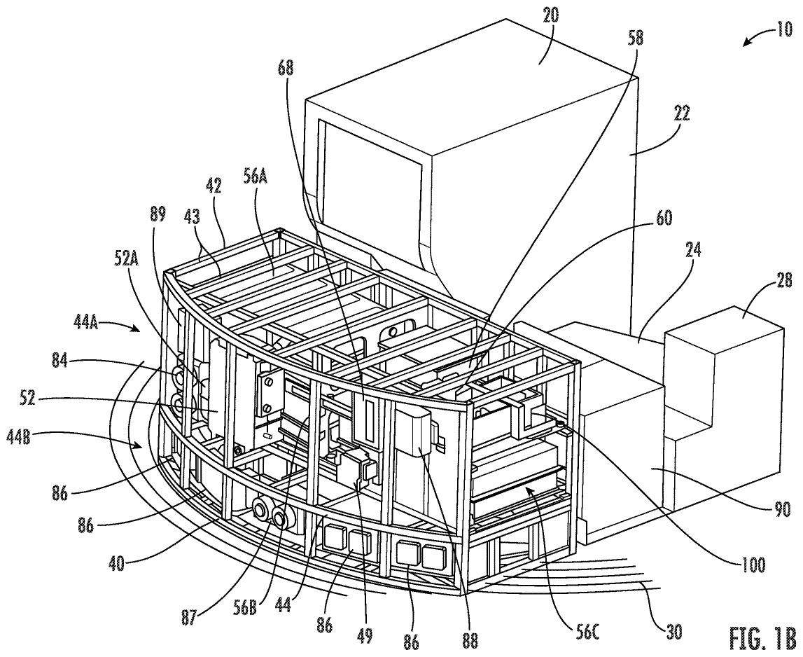

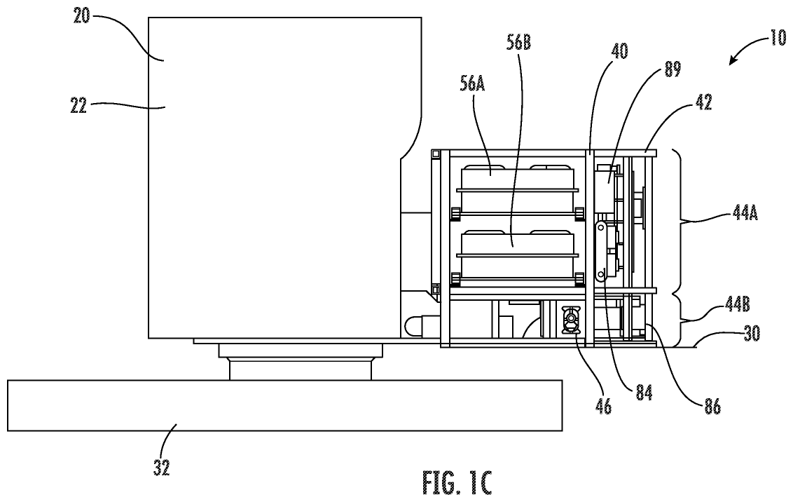

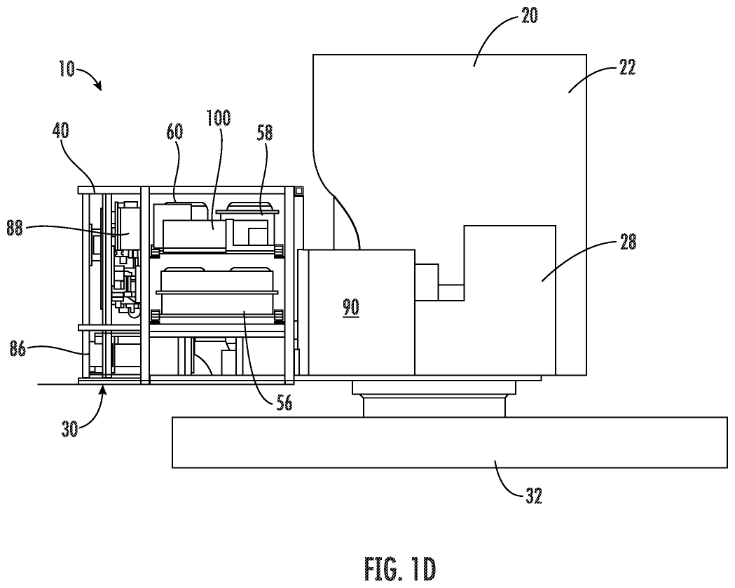

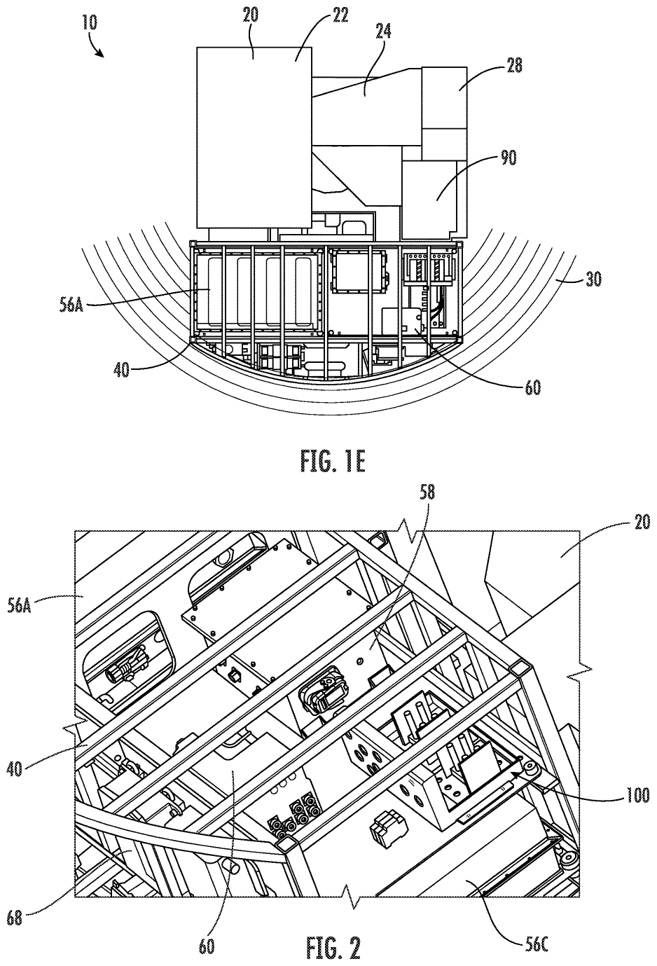

Referring now to the drawings, and particularly to FIGS. 1A-6D thereof, a modular electric mobile machine assembly is provided, a first embodiment of which is generally indicated at 10. Assembly 10 generally comprises electric mobile machine 20, mobile machine electric power module 40, and mobile machine electric motor module 90.

Mobile machine 20 is a piece of mobile heavy equipment and in this embodiment includes without limitation chassis 24, operator cabin 22, wheels or tracks 32, hydraulic actuators and equipment 26, hydraulic radiator 27, hydraulic tank 28, hydraulic pump 29, power mounting platform 30, cabin air conditioning radiator 31, connective wiring 33, and operator interfaces 36. Hydraulic actuators and equipment 26 are configured to be driven hydraulically by hydraulic pump 29 and hydraulic pump is configured to be driven by electric motor module 90. In this embodiment, mobile machine 20 is an excavator. While in this embodiment mobile machine 20 is an excavator, other types of mobile machines or vehicles with attached machinery or equipment that are self-propelled or mobile and that provide functionality beyond transport may be alternatives, including without limitation forklifts, skid steers, tractors, earthmovers, farm machinery, dump trucks, garbage trucks, mobile cranes, and other mobile construction equipment.

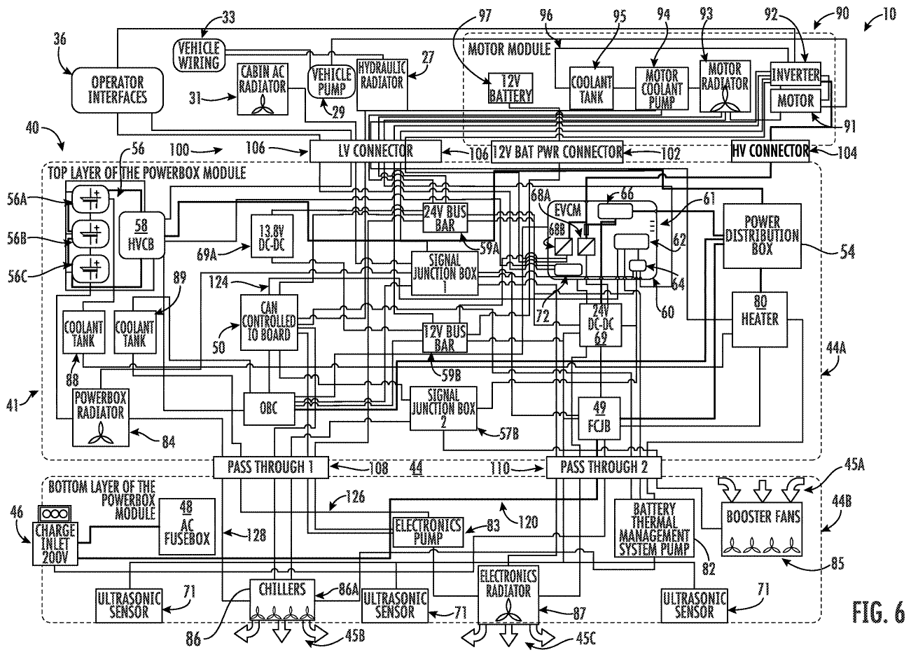

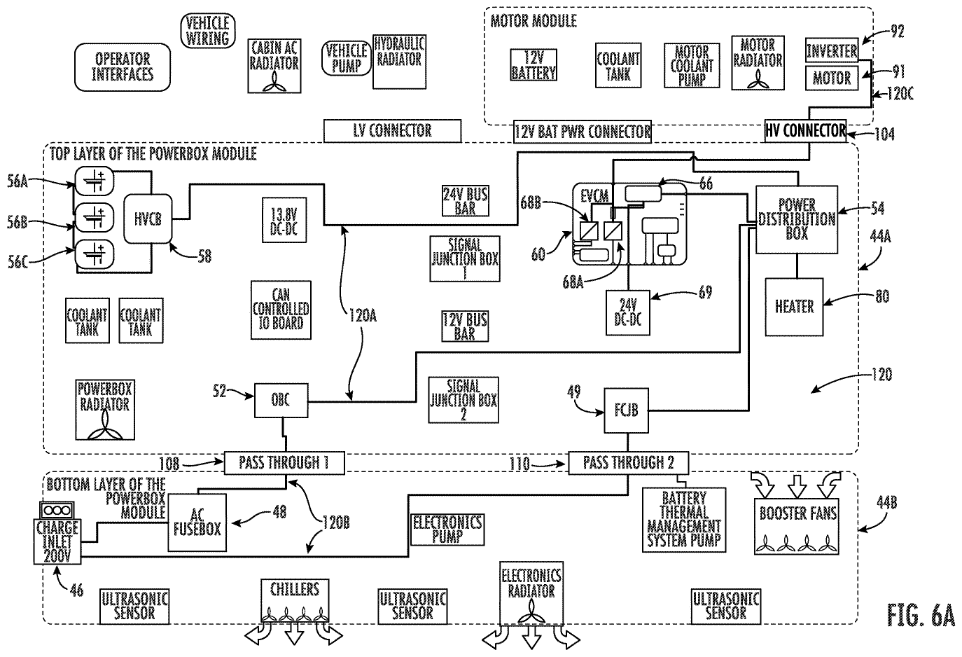

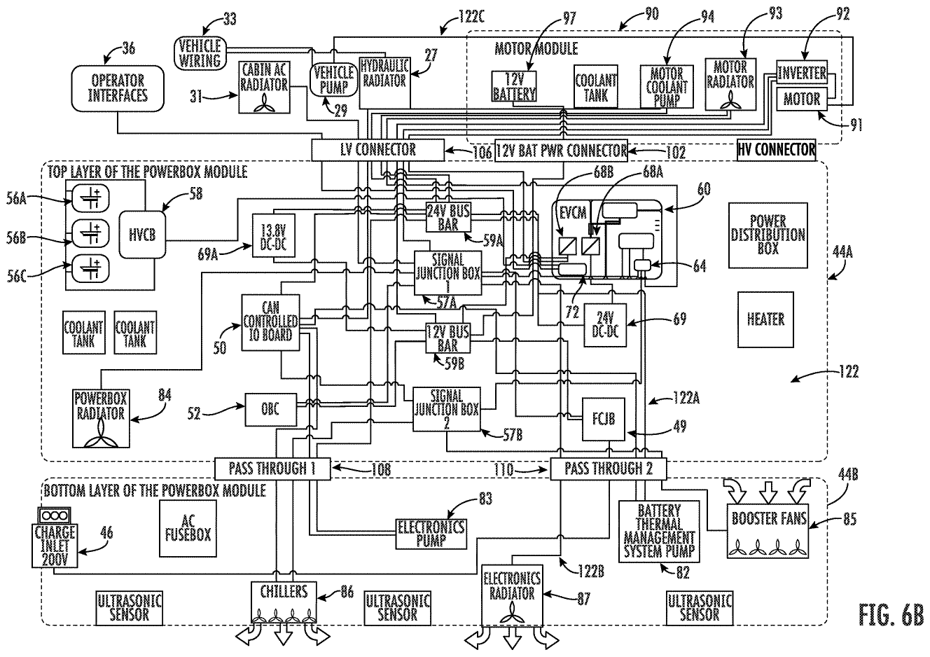

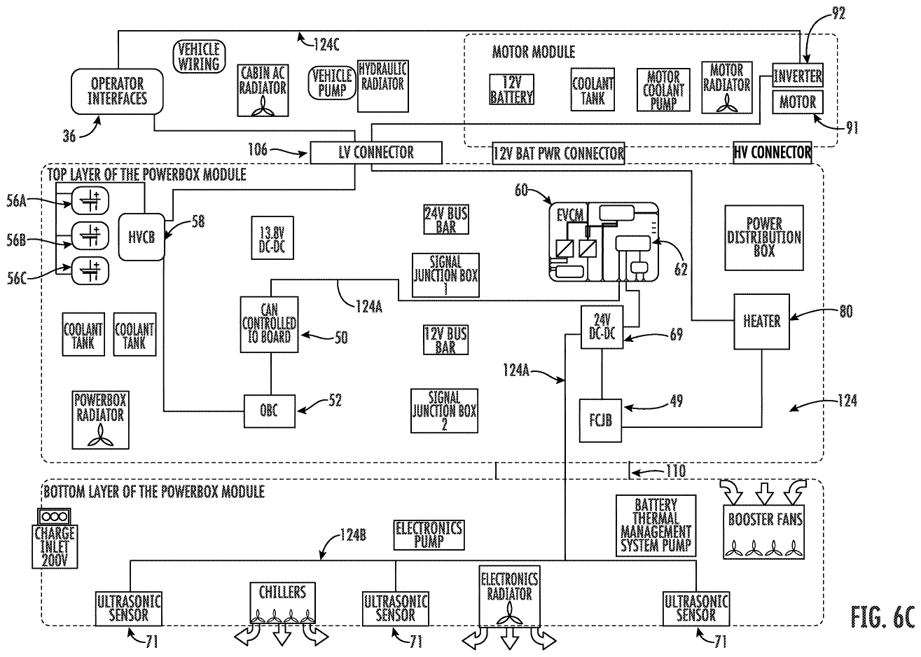

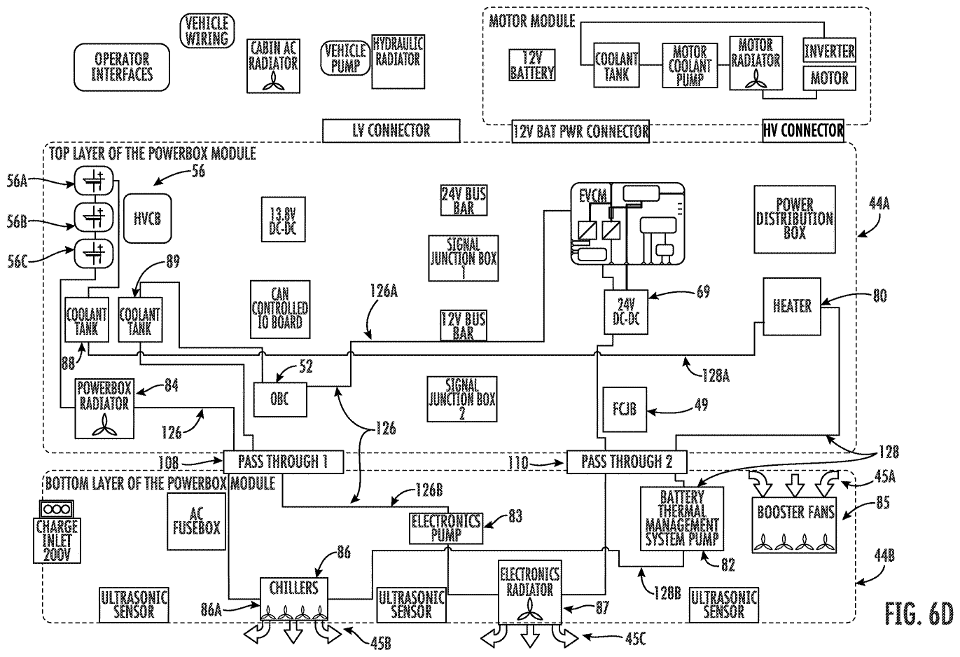

In this embodiment, motor module 90 contains electric AC motor 91, motor electronics and inverter 92, motor coolant radiator 93, motor coolant pump 94, motor coolant tank 95 and 12V battery 97. The output shaft of motor 91 is connected to hydraulic pump 29 and motor 91 drives pump 29 to operate the various hydraulic components of mobile machine 20. As shown in FIGS. 6-6D, motor 91 is powered by power module 40 via DC to AC inverter 92. Motor 91 and motor electronics and inverter 92 are cooled by coolant circulated in motor coolant circuit 96 through motor coolant tank 95 and motor coolant radiator 93 by motor coolant pump 94. Motor coolant radiator 93 and motor coolant pump 94 are powered by power module 40. Feedback signals from motor 91 are communicated to electric vehicle central module (EVCM) 60 of power module 40.

Mounting platform 30 is positioned at the rear of mobile machine 20 and sized such that power module 40 may be removably connected to mobile machine 20. Platform 30 may be fixedly secured to chassis 24 and in an exemplary embodiment may include a mechanical interface arranged on machine 20 to facilitate removable attachment with power module 40.

Hydraulic equipment 26 may comprise any number of components for operating various elements of mobile machine 20, examples of which include without limitation hydraulic cylinders that drive and control boom 34 of mobile machine 20. Hydraulic fluid utilized by hydraulic pump 29 is stored in hydraulic tank 28 and is temperature controlled by hydraulic radiator 27.

Cabin 22 is for the operator of mobile machine 20 and includes various components within the cabin, including without limitation cabin air conditioning radiator 31 for controlling the temperature within cabin 22 and operator interfaces 36. Operator interfaces 36 may include without limitation joysticks or vehicle controls, operator interface panels or displays, and operator overrides and command inputs. Cabin AC radiator 31 and operator interfaces 36 are powered by power module 40 via low voltage connector 106 and operator interfaces 36 are in data communication with motor module 90 and with power module 40 via low voltage connector 106.

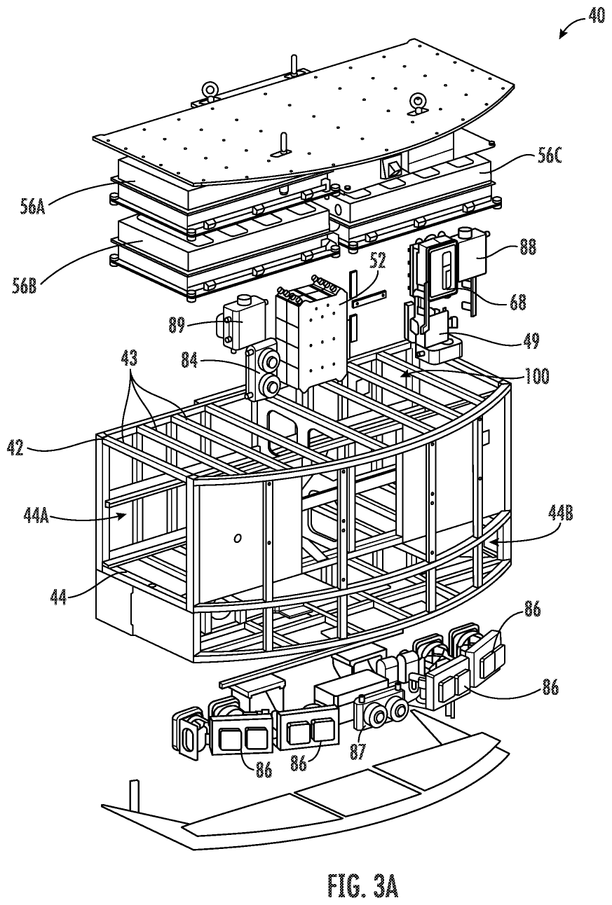

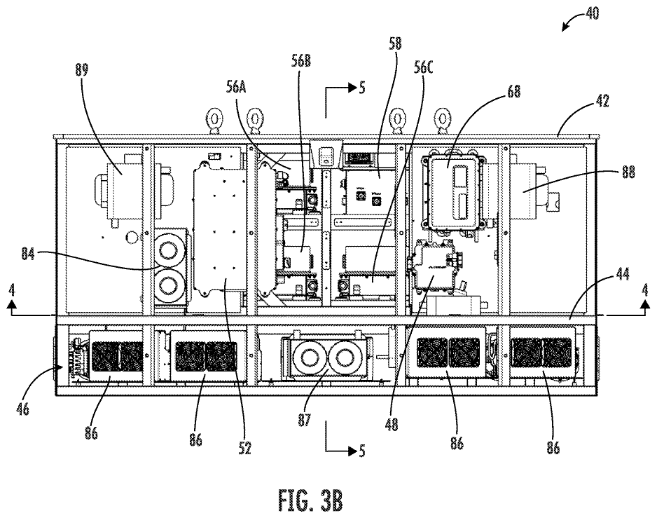

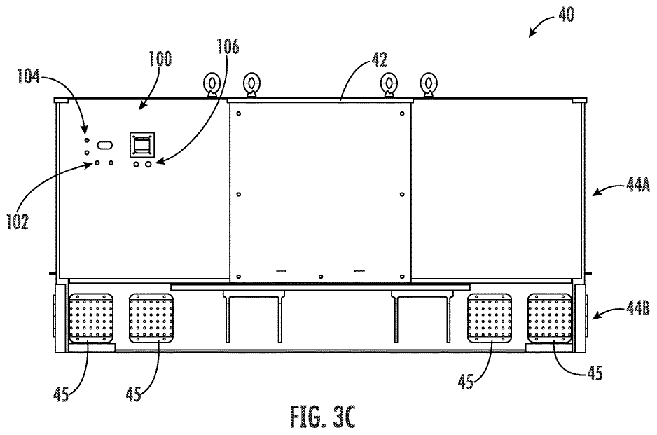

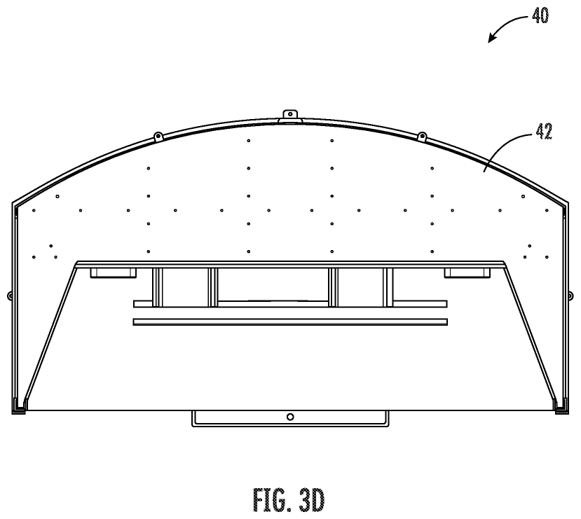

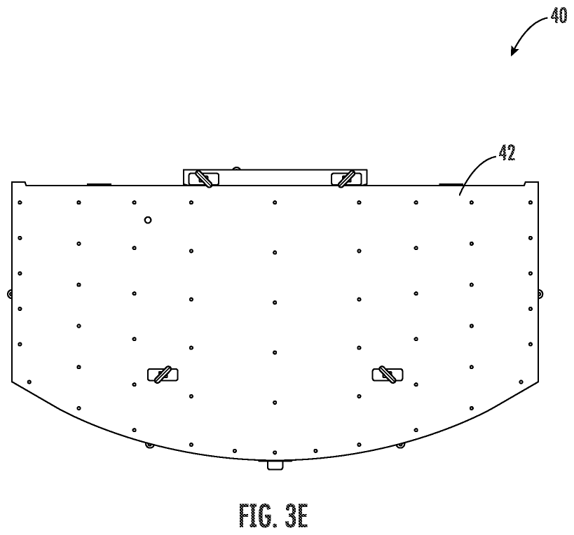

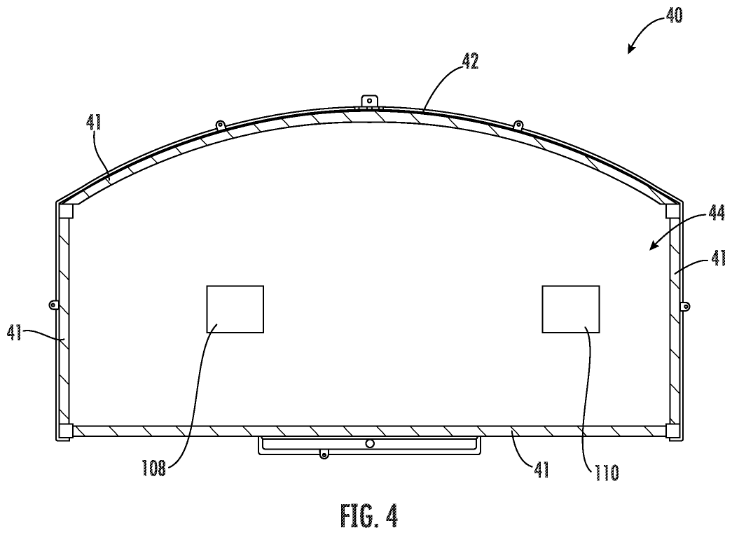

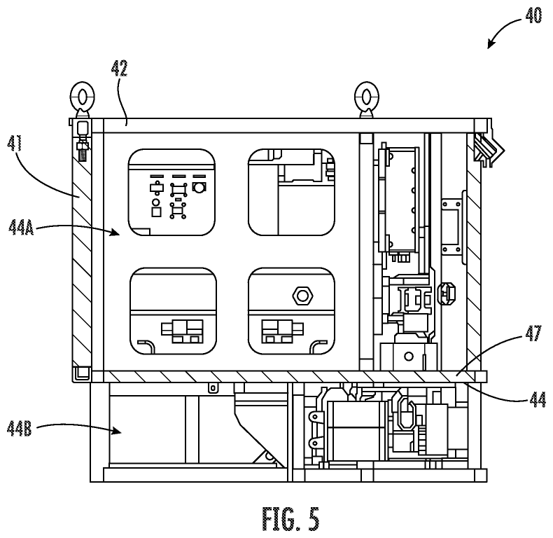

FIG. 3A is an exploded rear perspective view of module 40. FIG. 3B is a partial rear elevational view of module 40. FIG. 3C is a front elevational view of module 40. FIG. 3D is a bottom plan view of module 40. FIG. 3E is a top plan view of module 40. FIG. 3F is a right side elevational view of module 40. FIG. 3G is a left side elevational view of module 40. FIG. 4 is a cross-sectional view of module 40 taken generally along line 4-4 in FIG. 3B. FIG. 5 is a cross-sectional view of module 40 taken generally along line 5-5 in FIG. 3B. FIG. 6 is a schematic view of module 40.

Module 40 is arranged as a single integrated unit formed by structural housing 42 having rigid frame 43 supporting a protective and insulating outer shell or envelope 41, as best shown in FIG. 5. Housing 42 is operatively arranged to be removably secured to machine 20. In an exemplary embodiment, housing 42 is removably connectable to platform 30 adjacent to motor module 90. Housing 42 of module 40 generally encloses and contains the power electronics of module 40, at least one battery connected to the power electronics, for example battery pack 56 comprising batteries 56A-56C, the system controller for the module, for example EVCM 60, and the thermal management system for both the battery and the power electronics, for example systems 126 and 128.

Housing 42 may be divided into one or more sections or compartments. In this embodiment, housing 42 includes insulated partition 44 dividing the interior space of module 40 in two and forming upper section 44A and lower section 44B. In this embodiment, upper section 44A generally houses battery pack 56, module controller 60 and the power electronics of module 40 and lower section 44B generally houses the thermal management system for the battery and the power electronics.

In this embodiment, upper section 44A is fully enclosed or sealed so as to prevent the ingress of dirt, dust, and other pollutants and is also fully insulated so as to allow for thermal control of battery pack 56, module controller 60 and the power electronics of module 40 as part of thermal management of module 40. Lower section 44B is at least partially open to allow some airflow to certain thermal management components housed therein. First pass through 108 and second pass through 110 are provided in insulated partition wall 44 to provide a passage for high voltage, low voltage, data, and coolant conduit between upper section 44A and lower section 44B. Insulation 47 is arranged within partition wall 44, as best shown in FIG. 5.

In this embodiment, lower section 44B of housing 42 includes vehicle charging inlet connector or port 46 and vents 45. Vehicle charging inlet port 46 is arranged to be connected to an external electric power source (e.g., a charging gun) to charge batteries 56A-56C. Vents 45 are provided to facilitate controlled air flow in and out of lower section 44B, as shown in FIG. 3C. Upper section 44B of housing 42 comprises power distribution or output interface 100, which includes high voltage power outlet connector or port 104, 12V outlet connector or port 102, and low voltage and communication data connector or port 106. Output 100 is operatively arranged to facilitate fast and easy electrical and/or data connection between module 40 and both motor module 90 and machine 20. High voltage connector 104 is arranged to connect to motor module 90 and to connect high voltage power from battery pack 56 and EVCM 60 to electric motor 91 to power and drive electric motor 91. Low voltage connector 102 is arranged to connect to 12V battery 97 of mobile machine 20. Low voltage and data connector 106 is arranged to connect to motor module 90 and certain on board components of mobile machine 20. For example, connector ports 106 may be arranged to connect low voltage power from DC-DC converter 69 to low voltage components in machine 20, such as operator interfaces 36 and/or emergency stop devices, and to facilitate communication between motor module 90 and EVCM 60 and between operator interfaces 36 and EVCM 60. For example, EVCM 60 may communicate with or send signals to operator interfaces 36 to display the current charge in batteries 56A-56C via connector 106. In an exemplary embodiment, EVCM 60 may be further connected to external communications via ethernet and/or universal serial bus (USB) port 61 or may include a wireless transceiver for external communications.

In this embodiment, a plurality of ultrasonic sensors 71 are mounted on the side and rear exterior of lower section 44B of housing 42 of module 40. Combined, sensors 71 provide greater than 180 degrees of coverage within a range of 5 feet or 1.5 meters of mobile machine 20. As objects enter the field of coverage, sensors 71 detect the object in the range of coverage and communicate via data communication conduit 124 such detection and position back to system controller 62 of EVCM 60, which is driving and reading all of sensors 71. When an object is detected close to mobile machine, an audible and/or visual cue is provided via operator interface 36 to notify the operator of the obstacle. When an object is detected within a set threshold, such as for example 24 inches, EVCM 60 executes a stop command via control 72 that stops mobile machine 20 by sending electric motor 91 a low speed command that prevents further operation. Normal operation is commanded to resume when one of the following two conditions are met: (1) the obstacle moves or is moved outside the set threshold or (2) the operator presses an override button in cab 22, which is communicated to EVCM 60. Thus, EVCM includes a programmed safety system that includes monitoring for obstacles via sensors 71 and stop the mobile machine when obstacles are detected within a threshold range or otherwise providing a warning.

While ultrasonic sensors 71 are provided in this embodiment, other types of sensors may be used as alternatives or in addition to sensors 71 and may be operable to transmit their sensor data to EVCM 60, including without limitation a depth sensing camera, a global positioning system (“GPS”) receiver, an inertial measurement unit (“IMU”), a light detection and ranging unit (“LIDAR”), radar, and sensing bumpers. Sensors may be added to provide redundancy and meet safety requirements. Different combinations of different sensors may be deployed, and the locations of the sensors may be varied. For example, the mounting locations of the sensors may be expanded to provide coverage for the entire mobile machine, including the boom and implement doing the work. Main controller 62, or a separate controller dedicated to safety, may be implemented to fuse all of the inputs from the sensors and appropriately control mobile machine 20. In addition, rather than just have a shut-off command and an operator override, EVCM may communicate with the vehicle controls to only allow certain limited operations in response to a detected object. For example, if an object is detected in a certain direction, such as backing up, the controller would only allow motion in a direction away from the object, such as forward. Thus, in an exemplary embodiment, EVCM 60 may further comprises emergency stop control 72 operatively arranged to shut down various components or actions of mobile machine 20 in case of an emergency.

In this embodiment, insulated partition wall 44 and upper section 44A of housing 42 supports and contains batteries 56A-56C, high voltage circuit breakers 58, EVCM 60, 24V bus bar 59A, converter 69, converter 69B, 12V bus bar 57B, signal junction box 57A, signal junction box 57B, CAN controlled I/O board 50, radiator 84, on board charger 52, fast charge junction box 49, power distribution box 54, heater 80, coolant tank 88 and coolant tank 89. In this embodiment, lower section 44B of housing 42 supports and contains AC fuse box 48, chillers 86, battery coolant pump 82, radiator 87, electronics cooling pump 83, and intake fans 85.

As shown in FIGS. 6 and 6A, high voltage conduit or connectivity 120, including high voltage connectivity 120A in upper section 44A and high voltage connectivity 120B in lower section 44B, connect various components of module 40 and extend between charge inlet 46 and high voltage connector 104 of power module 40. In an exemplary embodiment, charge inlet 46 is configured to receive 240V single phase DC power from the external electric power source.

Vehicle charging inlet port 46 is electrically connected to both fuse box 48 and fast charge junction box 49. Fuse box 48 is electrically connected to and protects on board charger 52 and on board charger 52 provides regular speed charging of batteries 56A-56C. Vehicle charging inlet port 46 is also electrically connected to fast charge junction box 49 for fast charging of batteries 56A-56C. High voltage relay, busbar, or power distribution box 54 is electrically connected to on board charger 52 and fast charge junction box 49 and is operatively arranged to distribute high voltage power to battery pack 56, EVCM 60 and/or heater 80. In an exemplary embodiment, high voltage relay 54 is capable of stopping the supply of power to EVCM and/or battery pack 56.

Battery pack 56 comprises one or more batteries 56A-56C and battery management system 58 connected to high voltage relay 54. In this embodiment, battery pack 56 provides a 600 volt dc power source with 128 kwh capacity and fast charging capability. Battery management system 58 is operatively arranged to communicate with EVCM 60 and batteries 56A-56C. Battery management system 58 may comprise a high voltage circuit breaker operatively arranged to stop the flow of electricity to or from batteries 56A-56C if minimum or maximum thresholds are exceeded. For example, if EVCM 60 detects that a voltage level in batteries 56A-56C at or below a predetermined threshold, battery management system 58 stops the drawing of power from batteries 56A-56C to prevent over draining. Additionally, battery management system 58 prevents batteries 56A-56C from over charging, and thus prevents the supply of power to batteries 56A-56C if the charge therein is at or above a predetermined threshold. In an exemplary embodiment, battery pack 56 comprises a soft start feature, or the gradual turning on of batteries 56A-56C to avoid stressing the components of module 40 by the sudden current or voltage surges associated with the initial charging of electrical components.

EVCM 60 is electrically connected to relay 54 and is also electrically connected to inverter 92 of motor 91 via high voltage connector 104 and high voltage conductivity 120C so as to operatively power and drive motor 91. High voltage connector 104 is thereby arranged to connect high voltage power from battery pack 56 and EVCM 60 to electric motor 91 to power and drive electric motor 91.

EVCM includes over voltage protection 66 connected to high voltage relay 54 and internal DC-DC converters 68A and 68B. Over voltage protection 66 is a power supply feature which shuts down the supply or clamps the output when the voltage exceeds a predetermined threshold. Over voltage protection 66 is arranged to stop the flow of power to inverter 92 of motor module 90, internal converters 68A and 68B and/or external converter 69 if the supplied high voltage power from on board charger 52, fast charge junction box 49, or battery pack 56, via relay 54, exceeds a predetermined threshold so as to prevent damage to electronic components in power module 40, motor module 90, and mobile machine 20.

DC-DC converters 68A, 68B and 69 step down high voltage power received via relay 54 from battery pack 56, on board charger 52, or fast charge junction box 49 for the purpose of powering various low voltage devices. For example, DC-DC converters 68A, 68B and 69 may step down power from 600V to 24V, or from 240V to 28V, or from 240V to 12V. In this embodiment, converters 68A and 69 step down power to 24V and converter 68B steps down power to 12V.

As shown in FIGS. 6 and 6B, low voltage conduit or connectivity 122, including connectivity 122A in upper section 44A and connectivity 122B in lower section 44B, connect various components of module 40 and extend between converters 68A, 68B and 69, various components of module 40, and connectors 102 and 106 of power module 40.

EVCM includes input/output (I/O) module 64 and safety control 72 and upper section 44A includes 24V bus bar 59A connected to converter 69, 12V bus bar 57B connected to converter 68B, signal junction box 57A connected to I/O module 64, signal junction box 57B connected to I/O module 64, and connected CAN controlled I/O board 50. As shown in FIG. 6B, low voltage power and commands are thereby provided to various components of power module 40, including radiator 84, battery pack 56 and high voltage circuit breakers 58, I/O board 50, on board charger 52, fast charge junction box 49, chillers 86, battery coolant pump 82, radiator 87, electronics cooling pump 83, intake fans 85, and charge inlet 46. In addition, via connectors 102 and 106, low voltage power and commands are also thereby provided to various components of motor module 90 and mobile machine 20, including low voltage battery 97, motor coolant pump 94, motor radiator 93, inverter 92, motor 91, operator interfaces 36, and cabin air conditioner 31. In an exemplary embodiment, when EVCM 60 is receiving power from relay 54, DC-DC converter 68B charges low voltage battery 97 and when EVCM 60 is not receiving power, low voltage components may still draw power from low voltage battery 97. In an exemplary embodiment, EVCM 60 may also include a low voltage internal battery connected to converter 68B such that DC-DC converter 68B charges the battery when EVCM 60 is receiving power from relay 54, and when EVCM 60 is not receiving power, low voltage components of EVCM 60 may draw power from the battery.

As shown in FIGS. 6 and 6C, data communication connectivity 124, including connectivity 124A in upper section 44A and connectivity 124B in lower section 44B, connect various components of module 40 and extend between system control 62 of EVCM, various components of module 40, and connectors 106 of power module 40.

EVCM 60 includes system processor or control 62. System control 62 receives input signals and outputs command signals and is operatively arranged to control all components of module 40 and to receive and output communication signals external to power module 40 via module signal port 106 and in certain embodiments port 61. As shown in FIG. 6C, data communications are thereby provided between various components of power module 40, including battery pack 56 and high voltage circuit breakers 58, I/O board 50, on board charger 52, converter 69, fast charge junction box 49, heater 80, and sensors 71. In addition, via connector 106, data communications are also thereby provided between various components of motor module 90 and mobile machine 20, including inverter 92, motor 91, and operator interfaces 36.

In an exemplary embodiment, EVCM 60 communicates with the various components of module 40 and/or machine 20 using controller area network (CAN bus), allowing for microcontrollers and devices to communicate with each other's applications without a host computer. In an exemplary embodiment, EVCM 60 communicates with the various components of module 40 and/or machine 20 via a transceiver and wireless transmission.

Module 40 further comprises thermal regulating devices that operate in conjunction with housing 42 and insulated shell 41 to thermally manage the temperature of various components in power module 40. In this embodiment, two separate liquid thermal management systems or circuits 126 and 128 are self-contained in power module 40.

System 128 thermally manages battery pack 56 and generally comprises coolant tank 88 in upper section 44A, radiator 84 in upper section 44A, heater 80 in upper section 44A, battery coolant pump 82 in lower section 44B, and chillers 86 in lower section 44B. As shown, circuit 128 thermally regulates the temperature of battery pack 56 and each of batteries 56A-56C and is operable to cool them with chillers 86 or heat them with heater 80 so they are charged, discharged, and maintained within a desired temperature range, such as for example and without limitation about 84 degrees Fahrenheit. In this embodiment, each of batteries 56A-56C includes a flat plate heat exchanger and coolant is circulated from coolant tank 88 through such heat exchangers by battery coolant pump 82. In this embodiment, four separated chillers 86 are arranged in parallel and operatively cool the fluid circulated in system 128. In an exemplary embodiment, chillers 86 are vapor-compression refrigerant-based systems and comprise refrigerant, pumps, compressors, and air exhaust fans 86A powered by battery pack 56 and converter 69, with the air from fans 86A exhausted from power module 40 via vents 45B. In this embodiment, heater 80 operatively heats the fluid circulated in system 128. In an exemplary embodiment, heater 80 is an electric coil heater powered by battery pack 56 and relay 54. In an exemplary embodiment, system 128 may also include radiator 84 in upper section 44A operatively arranged to provide a heat exchange between the circulated coolant in system 128 and the air in upper section 44A of power module 40 to thereby provide either cooling or heating of the interior of upper section 44A of power module 40. In an exemplary embodiment, heat exchanger 84 is a radiator fan combo. Thus, chillers 86, heater 80 and heat exchanger 84 are operatively arranged to regulate the temperature of the coolant in system 128 and the air in upper section 44A in order to maintain the functionality of batteries 56A-56C within a predetermined temperature range. This thermal management system 128 in housing 42 has sufficient thermal authority to maintain batteries 56A-56C at an optimum temperature, keeping the batteries warm in cold environments and cool in hot environments. In an exemplary embodiment, the coolant may be glycol. In an alternative exemplary embodiment, the coolant may be water.

System 126 thermally manages the power electronics of module 60, including on board charger 52, EVCM 60, and converter 69. System 126 generally comprises coolant tank 89 in upper section 44A, radiator 87 in lower section 44B, and electronics coolant pump 83 in lower section 44B. As shown, circuit 126 thermally transfers heat generated by board charger 52, EVCM 60, and converter 69 from upper section 44A to lower section 44B and is operable to discharge the heat via radiator or heat exchanger 87 in lower section 44B. In this embodiment, board charger 52, EVCM 60, and converter 69 include flat plate heat exchangers and coolant is circulated from coolant tank 89 through such heat exchangers by battery coolant pump 83. Radiator 87 in lower section 44B is operatively arranged to provide a heat exchange between the circulated coolant in system 126 and ambient air to thereby exhaust the heat from circulated coolant in system 126 from lower section 44B via vent 45C. In an exemplary embodiment, heat exchanger 87 is a radiator fan combo. This thermal management system 126 in housing 42 has sufficient thermal authority to cool the power electronics, including the charging electronics and the discharging electronics, within upper section 44A of power module 40. In an exemplary embodiment, the coolant may be glycol. In an alternative exemplary embodiment, the coolant may be water.

In an exemplary embodiment, lower section 44B of power module 40 further comprises cooling fans 85 configured to circulate ambient air in through the interior of lower section 44B of power module 40 via vent 45A.

Power module 40 is operatively arranged to be removably connected to machine 20. In this embodiment, power module 40 is bolted to machine 20 and may be removed and replaced on platform 30 of mobile machine 20 in about 30 minutes. For example, if a module 40 requires service, it can be disconnected from the body of machine 20 and changed out with a new module 40 to minimize machine downtime. Module 40 may also be retrofitted to existing machines powered by internal combustion engines. In such cases, existing machines can be converted to electrical machines by removing the existing combustion engine, fuel tank, and cooling system of the machine and in their place connecting power module 40 and motor module 90 to the machine. An adapter may be connected to the now stripped machine for easy attachment with modules 40. In an exemplary embodiment, motor 91 can be arranged in housing 42 of module 40, rather than as a separate module 90. For example, motor 91 may be arranged in module 40 and can be connected, for example via a sprocket or gear train, to pump 29 arranged on the machine through a drive port in housing 42 of module 40. In this alternative embodiment, cooling system 126 may be expanded to cool motor 91 and inverter 92. In another example, both motor 91 and pump 29 may be arranged in housing 42 of module 40, and pump 29 may be fluidly connected to various hydraulic elements (e.g., cylinders) on the mobile machine, for example via one or more hoses and hydraulic ports in the housing of module 40.

Module 40 provides an interchangeable system and method for electrically powering movable machinery. Module 40 provides a number of advantages. Because module 40 may be used in the place of the internal combustion engine of a movable or mobile machine as its main power source, diesel powered mobile machines may be converted to electric power without the cost and waste of having to purchasing entirely new electrically powered movable machines. Modules 40 provides a battery pack that is liquid cooled, that is very compact, that is environmentally rugged, that is mechanically robust, and that is rated for environments such as compact earth moving equipment and mobile machines. System 10 minimizes external cables and hoses, provides increased operating voltage, and is easy to maintain. The modules may be line replaceable units (LRUs) and the module housing may provide desired Ingress Protection ratings. The module is a sealed unit and will stay clean inside, thereby reducing dirt or dust induced failures.

This disclosure has been described in detail with particular reference to an embodiment, but it will be understood that variations and modifications can be effected within the spirit and scope of the disclosure. The presently disclosed embodiments are therefore considered in all respects to be illustrative and not restrictive. The scope of the disclosure is indicated by the appended claims, and all changes that come within the meaning and range of equivalents thereof are intended to be embraced therein.

1. A modular mobile machine electric power system, comprising:
a housing;
a battery contained in said housing;
a charging inlet port in said housing;
charging electronics contained in said housing and connected between said charging inlet port and said battery;
a motor power outlet port in said housing configured to be operatively connected to an electric motor of a mobile machine;
discharging electronics contained in said housing and connected between said battery and said motor power outlet port;
a battery thermal management system contained in said housing;
a controller contained in said housing; and
said housing comprising a mechanical attachment configured to be operatively connected to said mobile machine.

2. The modular system set forth in claim 1, wherein said housing comprises an ambient air-sealed and insulated first compartment and an ambient air-open second compartment and wherein said battery and said controller are contained in said insulated first compartment.

3. (canceled)

4. The modular system set forth in claim 1, comprising a signal port in said housing connected to said controller.

5. (canceled)

6. The modular system set forth in claim 4, wherein said signal port is configured to be operatively connected to said electric motor of said mobile machine.

7. The modular system set forth in claim 1, wherein said battery comprises a plurality of batteries and battery management electronics and said charging electronics comprise a high voltage relay or busbar.

8. The modular system set forth in claim 1, comprising a signal outlet port in said housing connected to said controller.

9. The modular system set forth in claim 8, wherein said signal outlet port is configured to be operatively connected to a user interface of said mobile machine.

10. The modular system set forth in claim 1, comprising a low voltage outlet port in said housing configured to be operatively connected to an electric load of said mobile machine.

11. (canceled)

12. The modular system set forth in claim 11, wherein said electric load is selected from the group consisting of a battery, a user interface, a cabin air conditioner, and vehicle lighting.

13. The modular system set forth in claim 1, wherein said discharging electronics comprise a low voltage DC bus.

14. The modular system set forth in claim 1, wherein said discharging electronics comprise a voltage converter.

15. The modular system set forth in claim 1, wherein said battery thermal management system comprises a first coolant path, a first coolant pump configured to convey a liquid coolant in said first coolant path, and a first heat exchanger in said first coolant path.

16. The modular system set forth in claim 15, wherein said heat exchanger comprises at least one of a chiller, a heater, a radiator, and a cooling fan.

17. The modular system set forth in claim 15, wherein said battery thermal management system comprises a second coolant path separate from said first coolant path, a second coolant pump configured to convey a liquid coolant in said second coolant path, and a second heat exchanger in said second coolant path.

18. The modular system set forth in claim 1, comprising a controller battery configured to operatively power said controller.

19. The modular system set forth in claim 1, wherein said mechanical attachment comprises a housing flange having a plurality of mounting holes and a plurality of mounting bolts configured to extend through said respective mounting holes and to be operatively connected to a base of said mobile machine.

20. The mobile charging system set forth in claim 1, comprising a plurality of detection sensors operable to detect an object within a range of said housing and to transmit a signal to said controller.

21. (canceled)

22. The mobile charging system set forth in claim 20, wherein said controller is programmed to monitor for obstacles within a threshold range using said sensors and to provide a safety command in response to detection of an obstacle within said threshold range.

23. The modular system set forth in claim 1, wherein said mobile machine comprises a hydraulic pump driven by said electric motor and at least one hydraulic actuator connected to said hydraulic pump.

24. The modular system set forth in claim 23, wherein said mobile machine comprises an excavator.
